(19) United States
(12) Patent Application Publication
(10) Pub. No.: US 2018/0060647 A1
(43) Pub. Date: Mar. 1, 2018

(54) IMAGE PROCESSING APPARATUS, NON-TRANSITORY COMPUTER READABLE MEDIUM, AND IMAGE PROCESSING METHOD

(71) Applicant: FUJI XEROX CO., LTD., Tokyo (JP)

(72) Inventors: Yukihiro TSUBOSHITA, Kanagawa (JP); Ryota OZAKI, Kanagawa (JP); Ryosuke SHIGENAKA, Kanagawa (JP); Motofumi FUKUI, Kanagawa (JP); Noriji KATO, Kanagawa (JP)

(73) Assignee: FUJI XEROX CO., LTD., Tokyo (JP)

(21) Appl. No.: 15/447,788

(22) Filed: Mar. 2, 2017

(30) Foreign Application Priority Data
Aug. 31, 2016 (JP) 2016-169678

(51) Int. Cl. G06K 9/00; G06K 9/62

(52) U.S. Cl. CPC G06K 9/00288; G06K 9/6218; G06K 9/00268; G06K 9/00228

(57) ABSTRACT

An image processing apparatus includes a reception section, an image extraction section, a forming section, and a comparison section. The reception section receives a video. The image extraction section extracts target object images from multiple frames that constitute the video received by the reception section. The forming section forms multiple target object images among the target object images extracted by the image extraction section into one unit, the multiple target object images being temporally apart from each other. The comparison section makes a comparison on the basis of the unit formed by the forming section.

### CROSS-REFERENCE TO RELATED APPLICATIONS

This application is based on and claims priority under 35 USC 119 from Japanese Patent Application No. 2016-169678 filed Aug. 31, 2016.

### BACKGROUND

### Technical Field

The present invention relates to an image processing apparatus, a non-transitory computer readable medium, and an image processing method.

### SUMMARY

According to an aspect of the invention, there is provided an image processing apparatus including a reception section, an image extraction section, a forming section, and a comparison section. The reception section receives a video. The image extraction section extracts target object images from multiple frames that constitute the video received by the reception section. The forming section forms multiple target object images among the target object images extracted by the image extraction section into one unit, the multiple target object images being temporally apart from each other. The comparison section makes a comparison on the basis of the unit formed by the forming section.

### BRIEF DESCRIPTION OF THE DRAWINGS

Exemplary embodiments of the present invention will be described in detail based on the following figures, wherein:

FIG. 1 is a block diagram illustrating a hardware configuration of an image processing apparatus according to an exemplary embodiment of the present invention;

FIG. 2 is a functional block diagram illustrating functions implemented by the image processing apparatus according to an exemplary embodiment of the present invention;

FIG. 3 is a diagram for describing extraction of timeline segments in the image processing apparatus according to an exemplary embodiment of the present invention;

FIG. 4 is a diagram for describing an overlap between person regions of respective frames in the image processing apparatus according to an exemplary embodiment of the present invention;

FIG. 5 is a diagram for describing the occurrence of overlapping multiple persons in the image processing apparatus according to an exemplary embodiment of the present invention;

FIG. 6 is a diagram illustrating an overview of a first exemplary embodiment of the present invention;

FIG. 7 is a block diagram illustrating the details of a timeline segment comparison unit in the first exemplary embodiment of the present invention;

FIG. 8 is a flowchart illustrating an overall control flow of the first exemplary embodiment of the present invention;

FIG. 9 is a flowchart illustrating a control flow of a segment person identification process in the first exemplary embodiment of the present invention;

FIG. 10 is a diagram illustrating an overview of a second exemplary embodiment of the present invention;

FIG. 11 is a block diagram illustrating the details of the timeline segment comparison unit in the second exemplary embodiment of the present invention;

FIG. 12 is a block diagram illustrating the details of an inter-person distance determination unit in the second exemplary embodiment of the present invention;

FIG. 13 is a flowchart illustrating an overall control flow of the second exemplary embodiment of the present invention; and

FIG. 14 is a flowchart illustrating a control flow of an inter-segment distance calculation process in the second exemplary embodiment of the present invention.

### DETAILED DESCRIPTION

Now, exemplary embodiments of the present invention will be described in detail with reference to the drawings.

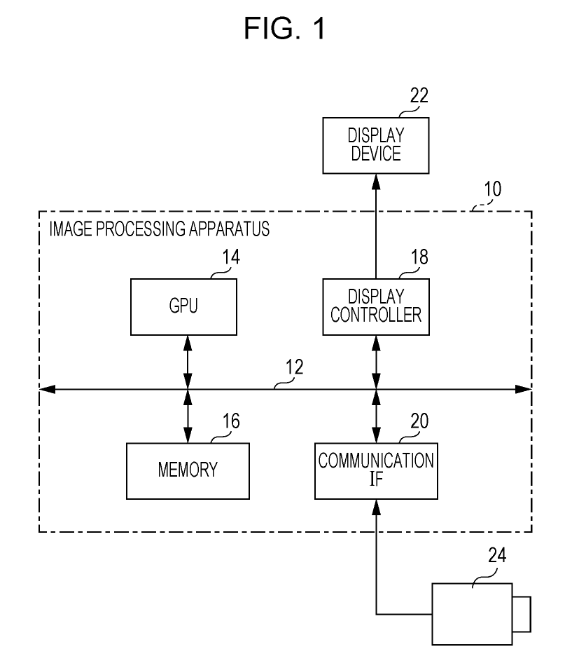

FIG. 1 is a block diagram illustrating a hardware configuration of an image processing apparatus 10 according to an exemplary embodiment of the present invention. The image processing apparatus 10 includes a graphics processing unit (GPU) 14, a memory 16, a display controller 18, and a communication interface 20, which are connected with one another via a bus 12. The GPU 14 has a function of a central processing unit (CPU) that operates in accordance with a program stored in the memory 16 and a function of parallel data processing. The display controller 18 is connected to a display device 22, such as a liquid crystal display, which displays a menu for operating the image processing apparatus 10, the operation state of the image processing apparatus 10, and so on. To the communication interface 20, a video from a camcorder 24 is input via the Internet or a local area network (LAN).

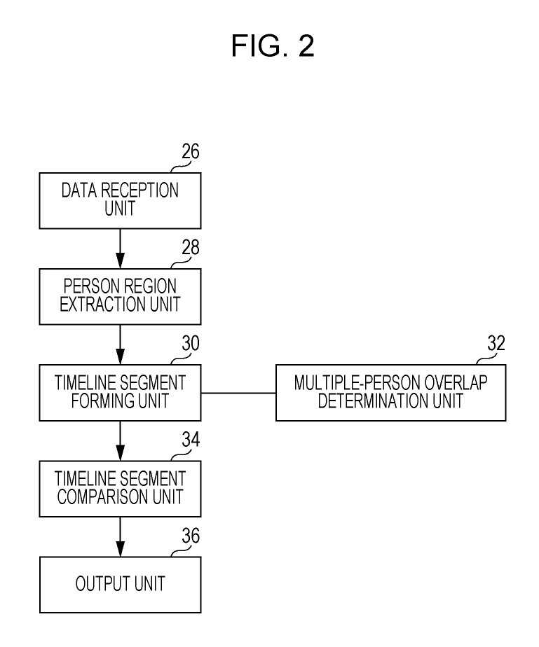

FIG. 2 is a functional block diagram illustrating functions implemented by the image processing apparatus 10 according to an exemplary embodiment of the present invention. A data reception unit 26 receives data including a video via the communication interface 20 described above.

A person region extraction unit 28 automatically extracts person regions typically as rectangular regions in a case where persons are included in frames (images) that constitute the video received by the data reception unit 26. Various methods have been proposed for person region detection, and any standard method may be used. One of the representative methods is Fast R-CNN described in R. Girshick, Fast R-CNN, arXiv:1504.08083, 2015, for example.

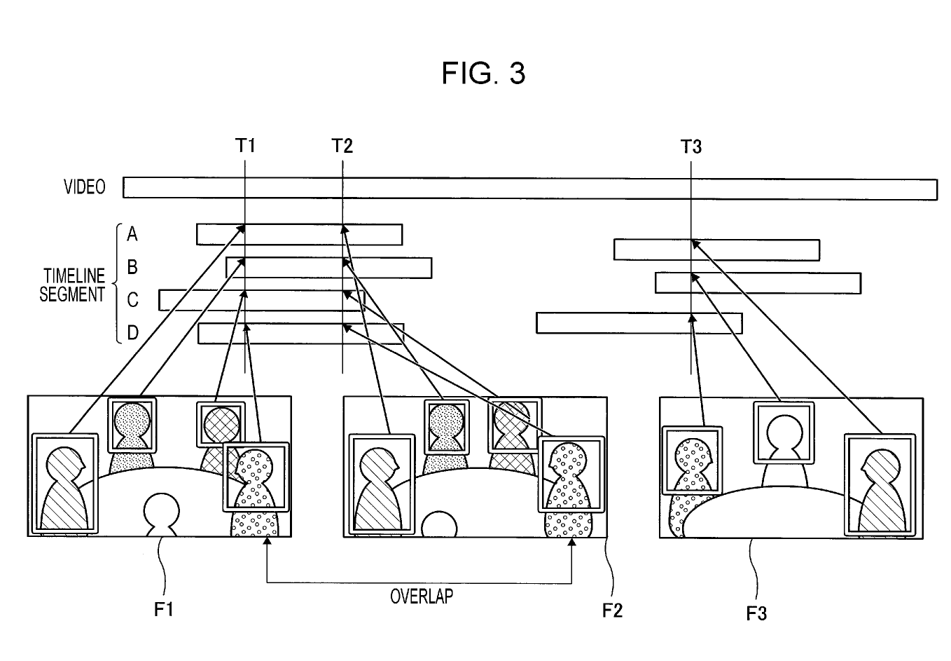

A timeline segment forming unit 30 forms the person regions extracted by the person region extraction unit 28 into a timeline segment as one unit. That is, as illustrated in FIG. 3, person region A to person region D extracted from frame F1 at time T1 are respectively compared with person region A to person region D extracted from frame F2 at time T2 in terms of the respective “overlaps” between the frames. In a case where any of the overlaps between the frames is large, the corresponding regions are merged and formed into a single timeline segment. In a case where any of the overlaps between the frames is small, the corresponding regions are respectively formed into different timeline segments. In a case of determining an overlap between frames, the overlapping state may be defined by, for example, expression (1) below.

$$OverLap = \frac{{S}_{3}}{min ( {S}_{1} , {S}_{2} )} \qquad ( 1 )$$

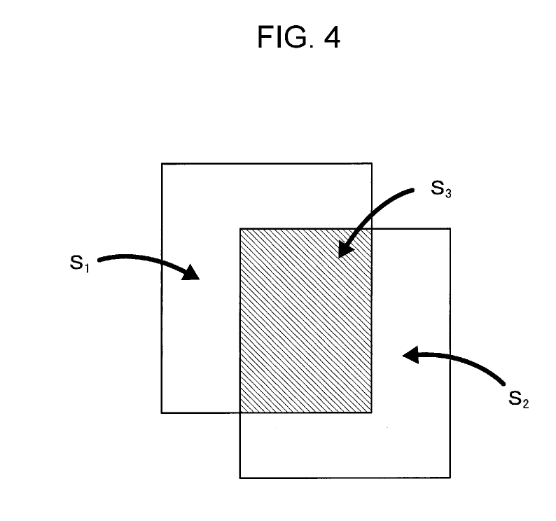

Here, S₁, S₂, and S₃ are the areas of portions defined in FIG. 4. A case where the overlap is equal to or larger than a predetermined threshold may be defined as the state where an overlap is present, and a case where the overlap is smaller than the predetermined threshold may be defined as the state where an overlap is not present.

Note that, as illustrated in FIG. 3, frame F3 at time T3 that is not continuous in the video is processed as a separate timeline segment.

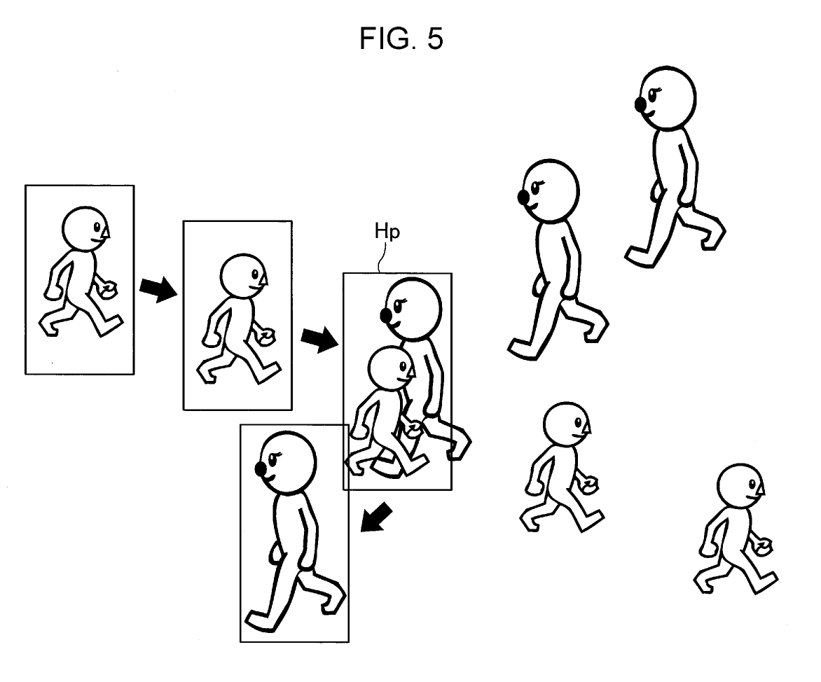

One of the problems about forming timeline segments is that, if persons overlap to an extremely large degree, timeline segments that are to be formed into different timeline segments of different persons are formed into the same timeline segment. That is, as illustrated in FIG. 5, there may be a case where a person region Hp is present in which person E and person F overlap. Accordingly, the timeline segment forming unit 30 is provided with a multiple-person overlap determination unit 32.

The multiple-person overlap determination unit 32 separates multiple persons into different timeline segments respectively before and after the multiple persons are in an overlapping state. Accordingly, it is possible to suppress erroneous detection of multiple persons belonging to a single timeline segment.

The multiple-person overlap determination unit 32 is configured as a binary classifier that is formed by, for example, preparing learning data in which any person region in which multiple persons are in the overlapping state is assumed to be a positive instance and any person region in which multiple persons are not in the overlapping state is assumed to be a negative instance, extracting features, and performing model learning. When extracting features, any image features, such as HOG (histogram of oriented gradients) feature values or SIFT+BoF feature values (scale-invariant feature transform and bag of features), may be extracted. In the model learning, a classifier, such as an SVM (support vector machine) classifier, may be used. Alternatively, it is possible to form a classifier directly from RGB inputs by using a convolutional neural network, such as AlexNet, which is a representative one described in A. Krizhevsky, I. Sutskever, G. E. Hinton, ImageNet Classification with Deep Convolutional Neural Networks, NIPS 2012.

A timeline segment comparison unit 34 compares timeline segments formed by the timeline segment forming unit 30 with each other. An output unit 36 causes the display device 22 to display the result of comparison made by the timeline segment comparison unit 34 via the display controller 18 described above, for example.

A comparison of timeline segments is made according to a first exemplary embodiment in which person identification is performed or according to a second exemplary embodiment in which the distance between persons is calculated.

First, the first exemplary embodiment is described.

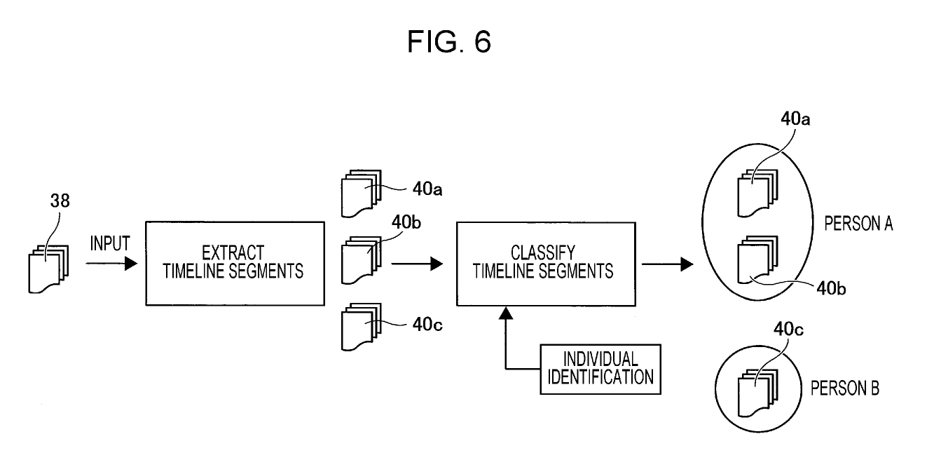

FIG. 6 illustrates an example in which scenes that include specific persons are extracted from a video 38, which is obtained by capturing a video of multiple persons, by using individual identification. First, when the video 38 is input, person regions are extracted as rectangular regions by using a person detection technique, and multiple timeline segments 40a, 40b, and 40c are extracted on the basis of the degree of overlap. Then, an individual is identified for each of the timeline segments 40a, 40b, and 40c by using an individual identification technique. In this example, scenes that include person A and person B that are registered in advance are extracted. By performing individual identification, the timeline segments 40a and 40b are classified as person A, and the timeline segment 40c is classified as person B.

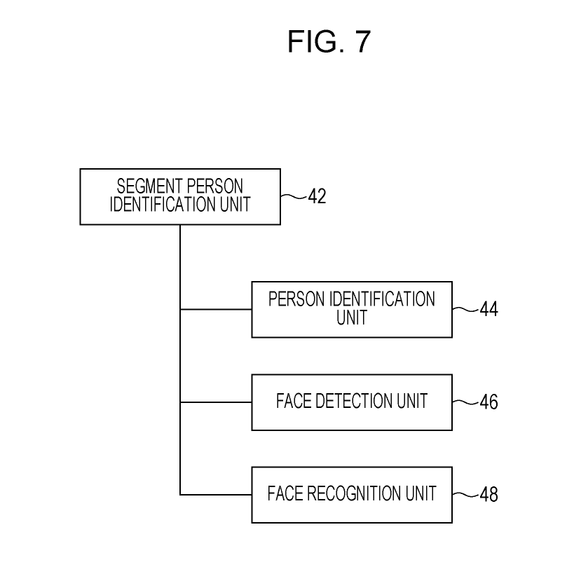

In the first exemplary embodiment, the timeline segment comparison unit 34 illustrated in FIG. 2 functions as a segment person identification unit 42 illustrated in FIG. 7.

The segment person identification unit 42 causes a person identification unit 44 to perform individual identification for each frame in a segment. When determination is performed on a segment, scores corresponding to each person ID are integrated to implement individual identification. As a method for integration, processing, such as adding up scores corresponding to each person ID, may be performed.

Further, the above-described individual identification may be combined with a face recognition technique that is widely used. In the case of combination, scores may be weighted and added up, for example.

Specifically, the segment person identification unit 42 includes the person identification unit 44, which is combined with a face detection unit 46 and a face recognition unit 48.

The person identification unit 44 is caused to learn in advance multiple persons present in a video and infers the IDs of the persons when a frame (image) in a segment is input. In the learning, all persons to be identified are respectively assigned IDs, person region images in which each person is present are collected as positive instances of the corresponding ID, and learning data is collected for the number of persons. The learning data is thus prepared, features are extracted, and model learning is performed to thereby form the person identification unit 44. When extracting features, any image features, such as HOG feature values or SIFT+BoF feature values, may be extracted. In the model learning, a classifier, such as an SVM classifier, may be used. Alternatively, it is possible to form a classifier directly from RGB inputs by using a convolutional neural network, such as AlexNet, which is a representative one described in A. Krizhevsky, I. Sutskever, G. E. Hinton, ImageNet Classification with Deep Convolutional Neural Networks, NIPS 2012.

The face detection unit 46 detects face regions when a frame in a segment is input.

The face recognition unit 48 calculates a score for each person ID that is assigned to a corresponding one of the persons registered in advance in a case where face detection by the face detection unit 46 is successful.

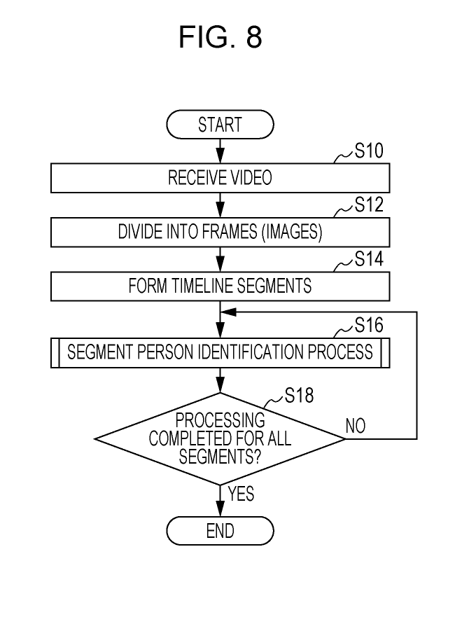

FIG. 8 is a flowchart illustrating a control flow in the first exemplary embodiment.

First, in step S10, a video is received. Next, in step S12, the video received in step S10 is divided into frames (images). In step S14, timeline segments are formed from the frames obtained as a result of division in step S12. In step S16, a segment person identification process is performed. In step S18, it is determined whether processing is completed for all of the segments. If it is determined that processing is completed for all of the segments (Yes in step S18), the flow ends. If it is determined that processing is not completed for all of the segments (No in step S18), the flow returns to step S16, and processing is repeated until the processing is completed for all of the segments.

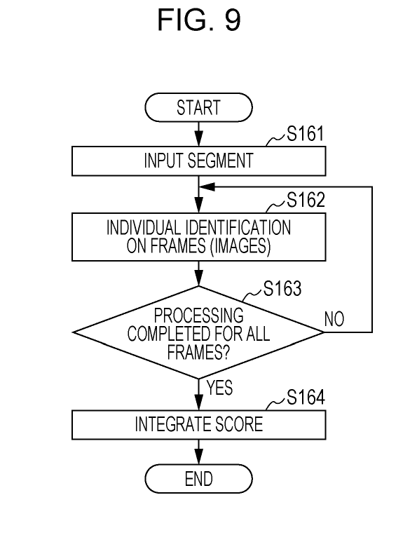

FIG. 9 is a flowchart illustrating a detailed control flow of the segment person identification process in step S16.

First, in step S161, a segment is input. Next, in step S162, individual identification is performed on the frames (images) obtained as a result of division in step S12 described above. In step S163, it is determined whether processing is completed for all of the frames. If processing is completed for all of the frames (Yes in step S163), the flow proceeds to step S164, a score calculated for each frame and for each person is integrated, and the flow ends. On the other hand, if it is determined that processing is not completed for all of the frames (No in step S163), the flow returns to step S162, and processing is repeated until the processing is completed for all of the frames.

Next, the second exemplary embodiment is described.

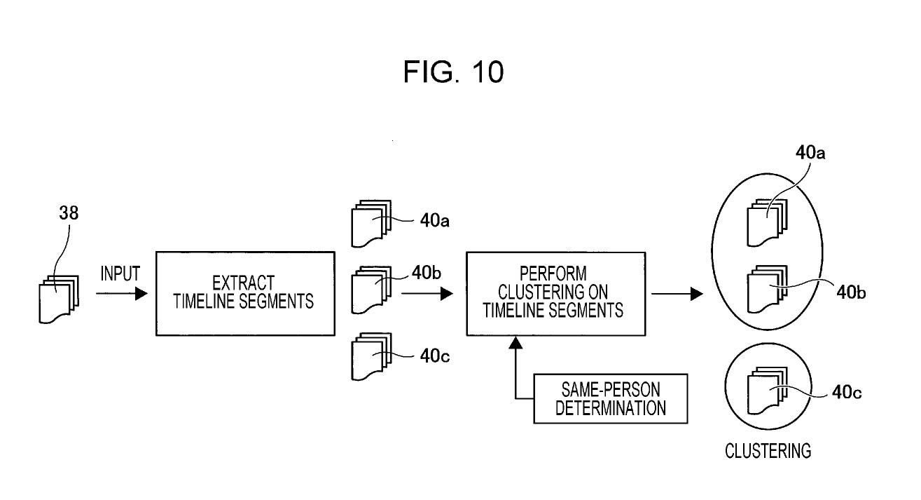

FIG. 10 illustrates an example in which scenes that include specific persons are extracted from the video 38, which is obtained by capturing a video of multiple persons, by using individual identification as in the first exemplary embodiment. First, when the video 38 is input, person regions are extracted as rectangular regions by using a person detection technique, and the multiple timeline segments 40a, 40b, and 40c are extracted on the basis of the degree of overlap. Then, clustering is performed on each of the timeline segments 40a, 40b, and 40c by using a same-person determination technique.

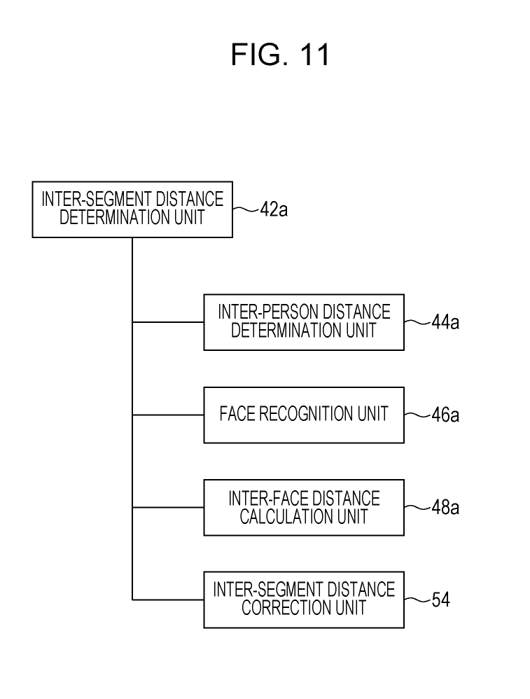

In the second exemplary embodiment, the timeline segment comparison unit 34 illustrated in FIG. 2 functions as an inter-segment distance determination unit 42a illustrated in FIG. 11.

The inter-segment distance determination unit 42a calculates the distance between two segments that are input. As the calculation method, the distance between each pair of frames respectively included in the two segments may be calculated and the average distance may be defined as the distance between the two segments. Alternatively, another method in which the distance between two segments is defined as the distance between sets, such as the Hausdorff distance, may be used, for example.

Further, the above-described distance calculation may be combined with a face recognition technique that is widely used. In the case of combination, scores may be weighted and added up, for example.

Specifically, the inter-segment distance determination unit 42a includes an inter-person distance determination unit 44a, which is combined with a face recognition unit 46a and an inter-face distance calculation unit 48a.

The inter-person distance determination unit 44a determines whether two persons respectively present in the two input segments are the same person.

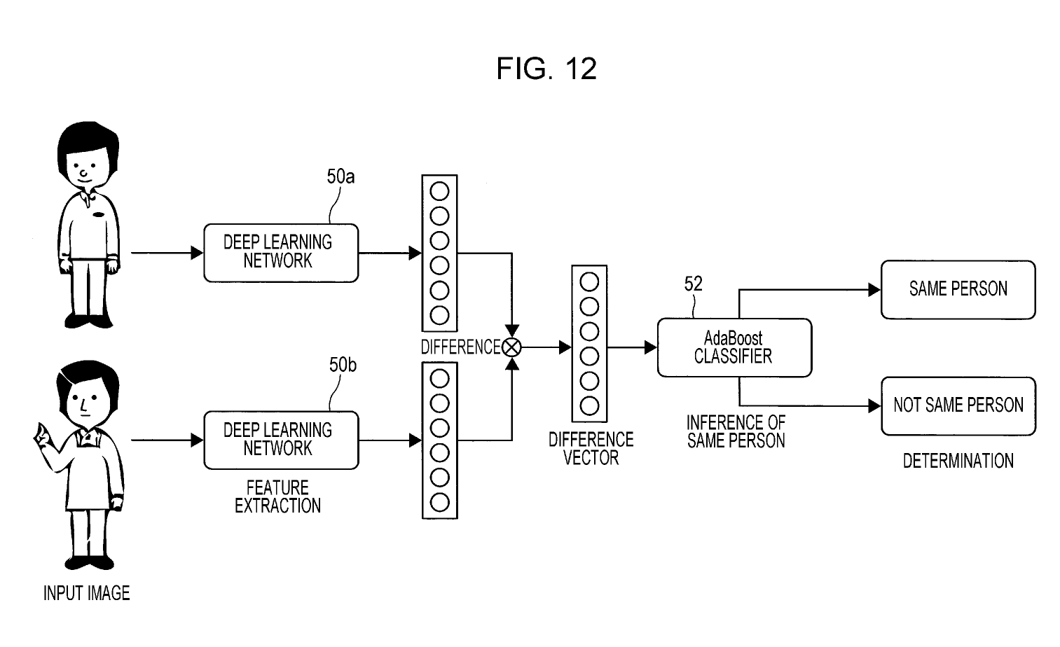

FIG. 12 illustrates an example of the inter-person distance determination unit 44a. In FIG. 12, deep learning networks 50a and 50b are used as feature extractors, the difference between the result of learning using the deep learning network 50a and the result of learning using the deep learning network 50b is calculated and assumed to be a difference vector, and inference as to whether the two persons are the same person is made by using an AdaBoost classifier 52 to thereby determine whether the two persons are the same person. This exemplary embodiment illustrates the configuration in which the AdaBoost classifier 52 is used as the classifier, which is an example as a matter of course.

Here, the configuration is employed in which a binary result, that is, whether or not the two persons are the same person, is returned. The inter-person distance may be defined by returning a predetermined small value in a case where the two persons are determined to be the same person and by returning a predetermined large value in a case where the two persons are determined to not be the same person.

Alternatively, a method of performing end-to-end processing from feature extraction to identification may be applicable by using deep learning as described in H. Liu, J. Feng, M. Qi, J. Jiang and S. Yan, End-to-End Comparative Attention Networks for Person Re-identification, IEEE Transactions on Image Processing, vol. 14, No. 8, June 2016 or in L. Wu, C. Shen, A. van den Hengel, PersonNet: Person Re-identification with Deep Convolutional Neural Networks, http://arxiv.org/abs/1601.07255.

The face recognition unit 46a detects and recognizes face regions when a frame in a segment is input. The inter-face distance calculation unit 48a calculates the distance between faces respectively present in two input frames in a case where face detection is successful. As a standard method for this, a method, such as OpenFace, described in F. Schroff, D. Kalenichenko, J. Philbin, FaceNet: A Unified Embedding for Face Recognition and Clustering, CVPR 2012, pp. 815-823 is available.

Further, an inter-segment distance correction unit 54 may be provided. The inter-segment distance correction unit 54 corrects the distance on the basis of a condition that segments that are present at the same time and in the same space always correspond to different persons.

The distance between the segments is thus determined, and clustering is performed. Clustering is performed on the basis of the distance between segments calculated by the inter-segment distance determination unit 42a. As the method for clustering, the k-means method or various hierarchical clustering methods, for example, may be used.

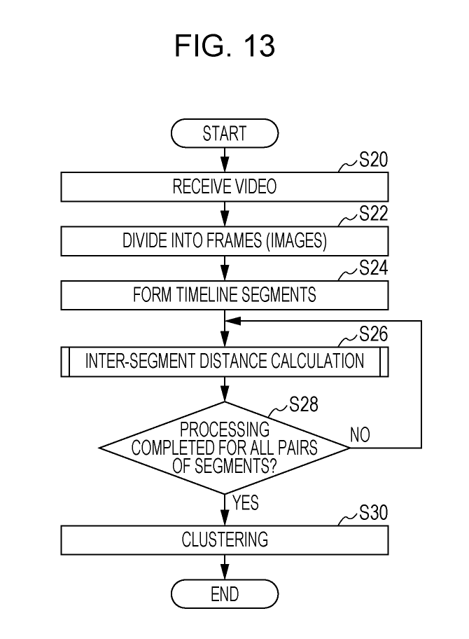

FIG. 13 is a flowchart illustrating a control flow in the second exemplary embodiment.

First, in step S20, a video is received. Next, in step S22, the video received in step S20 is divided into frames (images). In step S24, timeline segments are formed from the frames obtained as a result of division in step S22. In step S26, the distance between segments is calculated. In step S28, it is determined whether processing is completed for all pairs of segments. If it is determined that processing is completed for all pairs of segments (Yes in step S28), the flow proceeds to step S30, clustering is performed, and the flow ends. On the other hand, if it is determined that processing is not completed for all pairs of segments (No in step S28), the flow returns to step S26, and processing is repeated until the processing is completed for all pairs of segments.

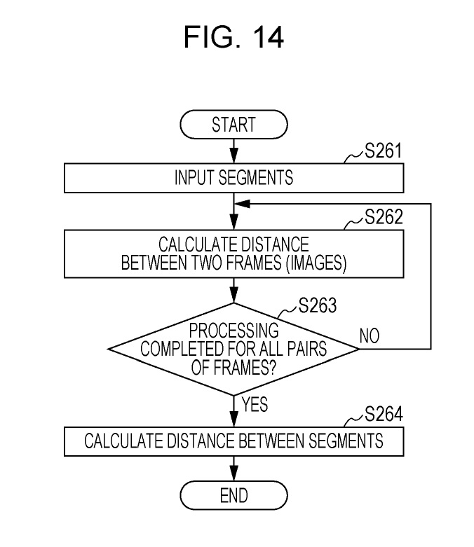

FIG. 14 is a flowchart illustrating a detailed control flow of the inter-segment distance calculation process in step S26.

First, in step S261, segments are input. Next, in step S262, for the frames (images) obtained as a result of division in step S22 described above, the distance between frames is calculated. In step S263, it is determined whether processing is completed for all pairs of frames. If processing is completed for all pairs of frames (Yes in step S263), the flow proceeds to step S264, the distance between the segments is calculated, and the flow ends. On the other hand, if it is determined that processing is not completed for all pairs of frames (No in step S263), the flow returns to step S262, and processing is repeated until the processing is completed for all pairs of frames.

Note that persons are assumed to be the target objects in the above-described exemplary embodiments; however, the target objects are not limited to persons, and any objects, such as animals or cars, for example, may be targets.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a reception section that receives a video;
an image extraction section that extracts target object images from a plurality of frames that constitute the video received by the reception section;
a forming section that forms a plurality of target object images among the target object images extracted by the image extraction section into one unit, the plurality of target object images being temporally apart from each other; and
a comparison section that makes a comparison on the basis of the unit formed by the forming section.

2. The image processing apparatus according to claim 1, wherein
the comparison section makes a comparison with a target object image registered in advance.

3. The image processing apparatus according to claim 1, wherein
the comparison section makes a comparison with target object images that constitute another unit.

4. The image processing apparatus according to claim 1, wherein
in a case where a plurality of target objects overlap, the forming section excludes a target object image of the overlapping target objects from the unit.

5. The image processing apparatus according to claim 1, wherein
the forming section forms, into the unit, target object images before a plurality of target objects overlap.

6. The image processing apparatus according to claim 1, wherein
the image extraction section extracts persons as target objects.

7. The image processing apparatus according to claim 5, wherein
the image extraction section performs face recognition.

8. A non-transitory computer readable medium storing a program causing a computer to execute a process for image processing, the process comprising:
receiving a video;
extracting target object images from a plurality of frames that constitute the received video;
forming a plurality of target object images among the extracted target object images into one unit, the plurality of target object images being temporally apart from each other; and
making a comparison on the basis of the formed unit.

9. An image processing method comprising:
receiving a video;
extracting target object images from a plurality of frames that constitute the received video;
forming a plurality of target object images among the extracted target object images into one unit, the plurality of target object images being temporally apart from each other; and
making a comparison on the basis of the formed unit.
